(19) United States
(12) Patent Application Publication
(10) Pub. No.: US 2023/0298802 A1
(43) Pub. Date: Sep. 21, 2023

(54) CHOKE ASSEMBLY AND ELECTRIC CONVERSION DEVICE

(71) Applicant: Delta Electronics (Thailand) Public Co., Ltd., Samutprakarn (TH)

(72) Inventors: Hugues NJIENDE, Paderborn (DE); Ralf GRIEGER, Soest (DE); Sergey TIKHONOV, Bad Sassendorf (DE)

(21) Appl. No.: 18/185,405

(22) Filed: Mar. 17, 2023

(30) Foreign Application Priority Data
Mar. 18, 2022 (EP) 22163040.3

(51) Int. Cl. H01F 27/26; H01F 27/30; H01F 27/29

(52) U.S. Cl. CPC H01F 27/26; H01F 27/306; H01F 27/292

(57) ABSTRACT

The present disclosure concerns a choke assembly (1), especially for an electric conversion device (100), comprising at least one rake-shaped core (2) respectively including a body portion (3), at least two winding legs (4), around each of which at least one electrical winding (5) is wound, and at least one return leg (6), wherein the at least two winding legs (4) and the at least one return leg (6) extend from the body portion (3) in a first direction (11), and at least one yoke core (7) connected to at least one rake-shaped core (2) and configured to close a magnetic circuit (8) between the at least two winding legs (4) and the at least one return leg (6) of the at least one rake-shaped core (2). The present disclosure also concerns an electric conversion device comprising the choke assembly (1).

### CROSS-REFERENCE TO RELATED APPLICATIONS

This application claims priority to European Patent Application No. 22163040.3, filed on Mar. 18, 2022, which is hereby incorporated by reference in its entirety.

### TECHNICAL FIELD

The present disclosure concerns a choke assembly, especially a choke assembly for an electric conversion device. The disclosure also concerns an electric conversion device comprising the choke assembly.

### BACKGROUND

Prior known power supplies employ paralleled or interleaved converters. However, these known approaches typically require a large quantity of expensive magnetic components, which results in high costs and a high volume or size of the device. Further, the known power supplies employing paralleled or interleaved converters have the disadvantages of low power density and low efficiency, especially low thermal efficiency.

### SUMMARY

The present disclosure concerns a choke assembly, especially for a converter circuit. The choke assembly comprises at least one rake-shaped core including a body portion, at least two winding legs, and at least one return leg. At least one electrical winding is wound around each winding leg. The at least two winding legs and the at least one return leg extend from the body portion in a first direction. Further, the choke assembly comprises at least one yoke core connected to the one rake-shaped core or connected to at least two of the rake-shaped cores. The yoke core is configured to close a magnetic circuit between the at least two winding legs and the at least one return leg of the at least one rake-shaped core.

With this configuration, the choke assembly of the present disclosure has the advantages that a size thereof is reduced, the quantity of components is reduced, and that the choke assembly can be easily and effectively cooled, thereby increasing the thermal efficiency thereof.

Preferably, no electrical windings are provided wound around the return leg(s). In other words, the return leg(s) preferably do not have any electrical windings wound around them.

Preferably, the yoke core does not comprise any electrical windings.

Advantageously, all winding legs combined have a first cross-sectional area, defined in a plane perpendicular to the first direction. All return legs combined have a second cross-sectional area, defined in the same plane. Preferably, the first cross-sectional area is 50% to 150%, more preferably 80% to 120% of the second cross-sectional area.

Preferably, the electrical winding of one winding leg is not directly electrically connected to the electrical winding of any further winding leg. In other words, the choke assembly preferably does not include any wires which are wound around one winding leg and extend to another winding leg, so as to also be wound around the other winding leg. On the other hand, the electrical windings are preferably electrically insulated, especially so as to allow a mechanical (physical, non-electrical) contact therebetween, while not allowing a direct electrical connection therebetween.

Thereby, preferably, the choke assembly includes a plurality of chokes, each defined by one electrical winding wound around one winding leg.

Further preferably, the choke assembly comprises a choke assembly input circuit and a choke assembly output circuit. Therein, the electrical winding of each winding leg is directly connected to the choke assembly input circuit and the choke assembly output circuit.

Preferably, an electrical wire of the respective electrical winding has one end connected to the choke assembly input circuit, has a portion wound around the respective winding leg, and has a further end, opposite to the end connected to the choke assembly input circuit, that is connected to the choke assembly output circuit. Further preferably, the electrical wire has only these portions. In other words, no further connections or windings are provided by this electrical wire.

Preferably, the aforementioned choke assembly input circuit is, for example, an output of a further circuit or component, for example an output of a transformer. The choke assembly input circuit can be any component or circuit which inputs an electrical signal, current and/or voltage into the choke assembly.

In an advantageous embodiment, each rake-shaped core includes one return leg for each pair of directly neighboring winding legs. In other words, the winding legs and the return leg(s) are alternately arranged.

For instance, in the special case that the rake-shaped core comprises two winding legs and one return leg, the return leg is preferably disposed between the two winding legs. In another special case, when the rake-shaped core comprises three winding legs, the rake-shaped core preferably comprises two return legs. Therein, the return legs are preferably arranged between neighboring winding legs. In detail, when the rake-shaped core comprises a first winding leg, a second winding leg, and a third winding leg, the rake shaped core preferably comprises a first return leg between the first winding leg and the second winding leg as well as a second return leg between the second winding leg and the third winding leg. In other words, the return legs and the winding legs are arranged in an alternating manner.

Preferably, the rake-shaped core extends in a first direction, a second direction, and a third direction. In other words, the rake-shaped core is three-dimensional. Therein, the first direction is preferably associated with a thickness of the rake-shaped core. The second direction is preferably associated with a width of the rake-shaped core. The third direction is preferably associated with a length of the rake-shaped core.

Advantageously, the winding legs and the return leg(s) are arranged, especially alternately, in the third direction (length) and extend from the body portion in the first direction (thickness). In other words, the return leg(s) and the winding legs alternate in the length direction of the rake-shaped core.

Further advantageously, at least two rake-shaped cores are stacked in the first direction. Therein, preferably, all rake-shaped cores of the choke assembly are stacked in the first direction. On the other hand, as will be explained below with more detail, the core preferably includes rake-shaped cores which are not stacked in the first direction. For instance, the choke assembly may comprise rake-shaped cores stacked in the first direction as well as at least one rake-shaped core not stacked with the others in the first direction.

Further preferably, not all rake-shaped cores of the choke assembly are comprised in the same stack. For instance, the choke assembly may comprise four or more rake-shaped cores, wherein two stacks of for example two rake-shaped cores each are provided.

In one advantageous embodiment, the at least two rake-shaped cores are stacked in the first direction such that end faces of the at least two winding legs and of the at least one return leg of one rake-shaped core face the body portion of a further rake-shaped core.

Preferably, the respective end faces of the at least two winding legs of one rake-shaped core are in contact with the body portion of the further rake-shaped core. Preferably, the end face(s) of the at least one return leg are not in contact with the body portion of the further rake-shaped core. In addition or alternatively thereto, combinations of non-contacting end faces of the winding legs and/or of contacting end faces of the return legs may be combined.

In an advantageous embodiment, the at least two rake-shaped cores are stacked in the first direction such that end faces of the at least two winding legs and of the at least one return leg of one rake-shaped core face opposite end faces of respective legs of a further rake-shaped core. In other words, the at least two rake-shaped cores are stacked in the first direction such that they are oriented in an opposing manner along the first direction. Thereby, the respective legs of the rake-shaped cores face each other or extend towards each other.

Preferably, the return legs of the two rake-shaped cores stacked in the first direction, especially their respective end faces, are in contact with one another. In other words, an end face of one return leg of a first rake-shaped core is in contact with an end face of one return leg of a second rake-shaped core.

Alternatively, the return legs of the two rake-shaped cores stacked in the first direction, especially their respective end faces, are not in contact with one another. Further preferably, in the case that at least one of the rake-shaped cores comprises more than one return leg, one or more of the return legs of the rake-shaped cores stacked in the first direction may be in contact with one another, whereas the others are not. In other words, the possibility of return legs being in contact with one another may be combined with the possibility of the return legs not being in contact with one another.

Further preferably, the winding legs of the two rake-shaped cores stacked in the first direction are not in contact with each other. That is, the winding legs of one rake-shaped core and the winding legs of the other rake-shaped core are not in contact with one another. Preferably, an air gap is formed between the respective winding legs of the two rake-shaped cores stacked in the first direction.

Further preferably, a gap between the winding legs of two different rake-shaped cores stacked in the first direction may be filled with a material or element with magnetic permeability.

Preferably, at least one yoke core is bar-shaped (also called “I-shaped”). Alternatively or in addition thereto, at least one yoke core comprises a yoke body portion and at least one yoke leg (also called “E-shaped”). Advantageously, a cross section perpendicular to a longitudinal axis of the at least one yoke core is rectangular or round, especially circular or oval/elliptical.

Further preferably, the yoke core is plate-shaped, especially flat plate-shaped. In one embodiment, the yoke core may be substantially flat-plate shaped and comprise at least one concave surface configured to receive a leg of the at least one rake-shaped core. Therein, the concave surface is preferably concave with respect to the first direction.

In an advantageous embodiment, the at least two rake-shaped cores are stacked in the first direction such that the end faces of the at least two winding legs and of the at least one return leg of at least one rake-shaped core face the at least one yoke core.

Preferably, some or all end faces of the at least two winding legs and of the at least one return leg of at least one rake-shaped core are in contact with the at least one yoke core. Preferably, for those end faces not in contact with the at least one yoke core, an air gap is provided between the respective end faces and the yoke core. In one embodiment, none of the end faces of the at least two winding legs and/or of the at least one return of at least one rake-shaped core are in contact with the at least one yoke core.

Preferably, the at least two rake-shaped cores and the at least one yoke core are stacked in the first direction such that only the legs of one rake-shaped core, especially their end faces, face the at least one yoke core. For example, the choke assembly may comprise two or more rake-shaped cores and one or more yoke core(s), wherein only the legs of one of the rake-shaped cores faces the yoke core(s). An illustrative example of this is also referred to as “EEI-configuration” or “EEII-configuration”.

Further preferably, with regard to the first direction, at least two rake-shaped cores are arranged so as to sandwich at least one yoke core. In other words, in the first direction, at least one rake-shaped core, at least one yoke core, and then at least one further rake-shaped core are stacked in the first direction. An illustrative example of this is also referred to as “EIE-configuration” or “EIIE-configuration”. Preferably, of the two rake-shaped cores directly neighboring (sandwiching) the at least one yoke core, one or both of these face the at least one yoke core, such that end faces of their respective legs face the at least one yoke core.

Preferably, two rake-shaped cores of the at least two rake-shaped cores sandwich exactly one yoke core. Preferably, the end faces of the legs of one or both rake-shaped cores face the yoke core.

In an advantageous embodiment, at least two rake-shaped cores are stacked in a second direction perpendicular to the first direction. Therein, the return legs of the at least two rake-shaped cores stacked in the second direction are preferably formed integrally with one another.

Further advantageously, body portions of the at least two rake-shaped cores, which are stacked in the second direction, are formed integrally with one another so as to morph into one singular body portion.

Preferably, the at least two rake-shaped cores may be stacked in the first and the second direction. In other words, the choke assembly preferably comprises at least three rake-shaped cores, wherein at least two rake-shaped cores are stacked in the first direction and, with respect to these rake-shaped cores stacked in the first direction, at least one rake-shaped core is stacked in the second direction. Preferably, each stack in the second direction comprises the same amount of rake-shaped cores stacked in the first direction. As an illustrative example, two rake-shaped cores are stacked in the first direction as a first stack, and two further rake-shaped cores are stacked in the first direction as a second stack, wherein the first stack and the second stack are stacked in the second direction.

Further preferably, each stack of rake-shaped cores (in the second direction) comprises the same number of yoke cores. As an illustrative example, a first stack may comprise, stacked in the first direction, two rake-shaped cores and one yoke core and a second stack may comprise, stacked in the first direction, two rake-shaped cores and one yoke core, wherein the first stack and the second stack are stacked in the second direction.

Preferably, the at least one return leg of the at least two rake-shaped cores stacked in the second direction are formed integrally with one another. That is, the return legs of one rake-shaped core are formed integrally with another rake-shaped core stacked in the second direction with the aforementioned one rake-shaped core. Preferably, only the return legs between (in the second direction) two neighboring rake-shaped cores are integral with one another. In this case, in the preferable embodiment that further rake-shaped cores (at least three in total) are stacked in the second direction, the return leg(s) of the further rake-shaped cores are not formed integrally with the integral return leg of the first two rake-shaped cores.

With respect to a preferable combination of the integral return leg and the return leg(s) and the winding legs alternating in the first direction, the integral return leg preferably comprises return leg portions which extend at least partially, along the second direction and/or third direction, to between two neighboring winding legs.

Preferably, at least two electrical windings, respectively wound around different winding legs, are mechanically, i.e. physically (not electrically), in contact with one another. In other words, one electrical winding wound around one winding leg of one rake-shaped core is in contact with another electrical winding wound around one winding leg of another rake-shaped core. The point or area of contact of these electrical windings is also called “contact portion”.

Advantageously, the at least two electrical windings in contact with one another are wound around winding legs of rake-shaped cores stacked in the second direction.

Preferably, at least two electrical windings neighboring each other in the third direction are in physical contact with one another. Preferably, at least two electrical windings neighboring each other in the in the third direction are in contact with one another, but not in contact with electrical windings neighboring these in the second direction. Alternatively or in addition thereto, at least two electrical windings neighboring each other in the third direction are not in contact with one another, but are in contact with electrical windings neighboring these in the second direction.

Further preferably, at least two electrical windings neighboring each other respectively in the second direction and the third direction are in contact with one another.

Advantageously, concerning the aforementioned at least two electrical windings (in second and/or third direction) being in physical contact with one another, all or some of these may preferably be disposed with a gap therebetween, i.e. not in physical contact with one another. Such a gap may preferably be small, for instance in the range of a few, preferably 1 to 5, millimeters.

In an advantageous embodiment, the at least one return leg, especially the at least one integral return leg, comprises a plurality of concave outer surfaces. The shape of each of the concave outer surfaces corresponds to a shape of an outer surface of an electrical winding of the adjacent winding leg.

Preferably, the concave outer surfaces extend, in the second direction and/or the third direction to between two neighboring electrical windings.

Further preferably, the concave outer surfaces extend in the second and/or third direction to between portions of neighboring electrical windings not in contact with one another, wherein preferably other portions between the neighboring electrical windings are in contact with one another or are preferably disposed with a small gap, preferably of a few millimeters, therebetween. In other words, the concave outer surfaces preferably extend to, but not including the contacting portions or the closest portions of neighboring electrical windings.

Preferably, the concave outer surfaces are round or oval, especially circular or semi-circular or (semi-)elliptical.

Further preferably, the outer surfaces of the at least one return leg are recessed in a rectangular manner. In other words, in addition or alternatively to the concave outer surface portions of the at least one return leg, the at least one return leg may comprise rectangular recesses. The rectangular recesses are especially configured so as to correspond to the shape of a rectangular outer surface of an electrical winding of the adjacent winding leg.

In an advantageous embodiment, a length in the first direction of the winding leg(s) is shorter than a length in the first direction of the return leg(s), so as to form at least one gap at an end of the winding leg(s) opposite to the body portion.

Preferably, irrespective of whether the shorter winding leg(s) face the body portion or an end face of another leg of another rake-shaped core, a gap is formed between the winding leg(s) and the element it is facing. Preferably, this gap may be an air gap. Further preferably, this gap may be filled with a material. This material is preferably a magnetic material with low magnetic permeability such as powder core.

Preferably, the return leg(s) contact the aforementioned element they are facing, especially due to their longer length in the first direction as compared to that of the shorter winding leg(s).

In one advantageous embodiment, in which the rake-shaped cores are arranged so as to face one another (end faces of legs facing each other) and/or in which the yoke core comprises legs, which face the rake-shaped core, the length of the opposing legs in the first direction may differ. Thereby, a gap or contact portion between respectively opposing legs is disposed preferably at the same height with respect to the first direction

In addition or alternatively thereto, a length in the first direction of different winding legs or different return legs, or between return legs and winding legs, of one rake-shaped core may differ. In this case, preferably, the lengths in the first direction of the aforementioned opposing legs of the other rake-shaped core and/or the yoke core also differ, especially correspondingly. In other words, as an illustrative example: one winding leg is shorter than another winding leg of the same rake-shaped core. These face winding legs of another rake-shaped core or legs of the yoke core, which all have the same length in the first direction. Thereby, the gap or contact portion between respectively opposing legs is disposed preferably at a different height with respect to the first direction, as compared to the gap or contact portion between different pairs of opposing legs. In other words, gaps between different pairs of legs may be disposed at different heights with respect to the first direction.

Preferably, at least the outermost legs out of all winding legs and the return leg(s) are winding legs. Preferably, at least the outermost legs in the second and/or third direction are winding legs. As an illustrative example, in the case that the rake-shaped core comprises three legs, the two, in the first direction, outermost legs are winding legs, whereas the middle leg is a return leg. In a further illustrative example, in the case that the rake-shaped core comprises five legs, the two outermost legs as well as the middle leg are winding legs. The two legs between the winding legs are return legs.

Advantageously, the choke assembly comprises a cooling device configured to thermally cool the choke assembly. In particular, the cooling device may be an air-cooling or liquid-cooling device. By preferably placing the winding legs primarily as the outermost legs of the choke assembly, the cooling of the choke assembly can be carried out more efficiently.

In an advantageous embodiment, the choke assembly is a surface mounted device. Preferably, the choke assembly is surface mounted on a circuit board, especially a printed circuit board.

Preferably, the choke assembly comprises two rake-shaped cores and one yoke core. Herein, each rake-shaped core preferably comprises two winding legs and one return leg. The yoke core is preferably bar-shaped. Preferably, in the first direction, the first rake-shaped core is stacked on top of the second rake-shaped core and the second rake-shaped core is stacked on top of the yoke core. The legs of the first rake-shaped core face the body portion of the second rake-shaped core. The legs of the second rake-shaped core face the yoke core.

Preferably, the choke assembly comprises two rake-shaped cores and one yoke core. Herein, each rake-shaped core preferably comprises two winding legs and one return leg. The yoke core is preferably bar-shaped. Preferably, in the first direction, the first rake-shaped core is stacked on top of the yoke core and the yoke core is stacked on top of the second rake-shaped core. The legs of both the first and the second rake-shaped core face the yoke core. In other words, the yoke core is sandwiched between two rake-shaped cores, with both rake-shaped cores facing the yoke core.

Further preferably, the choke assembly comprises two rake-shaped cores and one yoke core. Herein, each rake-shaped core preferably comprises two winding legs and one return leg. The yoke core preferably comprises three leg portions and a body portion. Preferably, the first rake-shaped core is stacked, in the first direction, on top of the second rake-shaped core and the second rake-shaped core is stacked on top of the yoke core. The legs of the yoke core, in particular the end faces of the legs of the yoke core, face the end faces of the legs of the second rake-shaped core. A gap is preferably provided between the winding legs of the second rake-shaped core and the legs of the yoke core opposing the winding legs of the rake-shaped core.

Preferably, no gap is provided between the (third) leg of the yoke core and the return leg of the rake-shaped core opposing said leg of the yoke core.

Advantageously, the gap(s) are provided between the return legs and the legs of the yoke core opposing the return legs of the rake-shaped core. Therein, preferably, no gaps are provided between the winding legs of the rake-shaped core and the opposing legs of the yoke core (i.e. air gaps at the ends of the return legs in addition or alternatively to the air gaps at the ends of the winding legs).

Preferably, the choke assembly comprises two rake-shaped cores and one yoke core, wherein the rake-shaped cores include three winding legs and two return legs, respectively disposed between the winding legs. The yoke core is preferably bar-shaped.

In the aforementioned case, in the first direction, the first rake-shaped core is stacked on the second rake-shaped core and the second rake-shaped core is stacked on the yoke core. Therein, the legs of the first rake-shaped core face the body portion of the second rake-shaped core. The legs of the second rake-shaped core face the yoke core.

Further preferably, in the aforementioned case, in the first direction, the first rake-shaped core is stacked on top of the yoke core and the yoke core is stacked on the second rake-shaped core. Therein, preferably, the legs of both the rake-shaped cores face the yoke core.

Further preferably, the choke assembly comprises two rake-shaped cores and one yoke core, wherein the rake-shaped cores comprise three winding legs and two return legs and the yoke core comprises five legs and a body portion. Therein, in the first direction, the first rake-shaped core is stacked on the second rake-shaped core and the second rake-shaped core is stacked on top of the yoke core. Preferably, the legs of the second rake-shaped core face the legs of the yoke core. The end faces of the winding legs of the second rake-shaped core preferably do not contact the opposing legs of the yoke core. The end faces of the return legs of the second rake-shaped core preferably contact the opposing legs of the yoke core. The winding legs of the first rake-shaped core preferably do not contact the body portion of the second rake-shaped core. The return legs of the first rake-shaped core preferably contact the body portion of the second rake-shaped core.

Any of the aforementioned preferable configurations may be combined with one another. Further, the structures described therein may especially be repeated or extended in the first direction and/or the second direction and/or the third direction. As an illustrative example, the choke assembly preferably comprises four rake-shaped cores and one yoke core. The yoke core is preferably disposed between two of the four rake shaped core or, in the first direction, under the fourth rake-shaped core. Further, additional, especially bar-shaped, yoke cores are preferably disposed, in the first direction, between neighboring rake-shaped cores.

The rake-shaped cores and the yoke core(s) are preferably formed of a ferrite material. The electrical windings are preferably formed of an insulated copper wire. Each core described herein is preferably made in one piece, so that, for example, the body portion together with the winding and return legs form one part, whereas the yoke core is another part.

In the foregoing, air gaps have been described as being disposed at the ends of the winding legs. On the other hand, air gaps are preferably also disposed at the ends of one or more of the return legs. Further preferably, the air gaps are disposed at the ends of one or more of the return legs instead of those disposed at the ends of the winding legs.

The present disclosure also concerns an electric conversion device. The electric conversion device comprises at least one choke assembly according to any one of the embodiments described above. Further, the electric conversion device comprises a transformer and/or a converter, preferably a power converter. The electric conversion device is preferably a power conversion device. In particular, the electric conversion device is advantageously a surface mounted electric conversion device.

In the electric conversion device, the aforementioned choke assembly input circuit is preferably an input of the entire electric conversion device. In contrast, the choke assembly input circuit is preferably at least one converter, more specifically an output of at least one of the converter(s).

Further preferably, the aforementioned choke assembly output circuit is preferably an output of the electric conversion device. In contrast, the choke assembly output circuit is preferably at least one converter, more specifically an input of at least one of the converter(s).

The choke assembly and the electric conversion device provide the benefits of lower copper losses, especially alternating current losses, higher power efficiency, better electromagnetic interference behavior, a reduced total volume, higher device power density, improved cooling of windings and cores, reduced temperature increase, reduced likelihood of hot spots, lower material costs, and lower labor costs for the manufacturing thereof.

### BRIEF DESCRIPTION OF DRAWINGS

Further details, advantages, and features of the preferred embodiments of the present disclosure are described in detail with reference to the figures. Therein:

FIG. 1 shows a schematic side view of a choke assembly according to a first embodiment of the present disclosure.

FIG. 2 shows a schematic side view of a choke assembly according to a second embodiment of the present disclosure.

FIG. 3 shows a schematic side view of a choke assembly according to a third embodiment of the present disclosure.

FIG. 4 shows a schematic side view of cores of the choke assembly according to the second embodiment of the present disclosure.

FIG. 5 shows a schematic side view of cores of a choke assembly according to a fourth embodiment of the present disclosure.

FIG. 6 shows a schematic side view of cores of a choke assembly according to a fifth embodiment of the present disclosure.

FIG. 7 shows a schematic side view of a choke assembly according to a sixth embodiment of the present disclosure.

FIG. 8 shows a schematic side view of a choke assembly according to a seventh embodiment of the present disclosure.

FIG. 9 shows a schematic side view of a choke assembly according to an eighth embodiment of the present disclosure.

FIG. 10 shows a schematic side view of cores of a choke assembly according to the seventh embodiment of the present disclosure.

FIG. 11 shows a schematic side view of cores of a choke assembly according to a ninth embodiment of the present disclosure.

FIG. 12 shows a schematic side view of cores of a choke assembly according to a tenth embodiment of the present disclosure.

FIG. 13 shows a schematic plan view of a choke assembly according to an eleventh embodiment of the present disclosure.

FIG. 14 shows a schematic plan view of a choke assembly according to a twelfth embodiment of the present disclosure.

FIG. 15 shows a schematic plan view of a choke assembly according to a thirteenth embodiment of the present disclosure.

FIG. 16 shows a schematic plan view of a choke assembly according to a fourteenth embodiment of the present disclosure.

FIG. 17 shows a schematic plan view of a choke assembly according to a fifteenth embodiment of the present disclosure.

FIG. 18 shows a schematic plan view of a choke assembly according to a sixteenth embodiment of the present disclosure.

FIG. 19 shows a schematic diagram of an electric conversion device according to the present disclosure.

### DESCRIPTION OF EMBODIMENTS

It is an object of the present disclosure to provide a choke assembly, especially for an electric conversion device, which overcomes the aforementioned disadvantages. In particular, an object of the present disclosure is to provide a choke assembly with a low quantity of magnetic components, a low volume or size, and high thermal efficiency. Further, it is an object of the present disclosure to provide an electric conversion device with these advantages.

The solution of these objects is solved by the features of the independent claims. The dependent claims contain advantageous embodiments of the present disclosure.

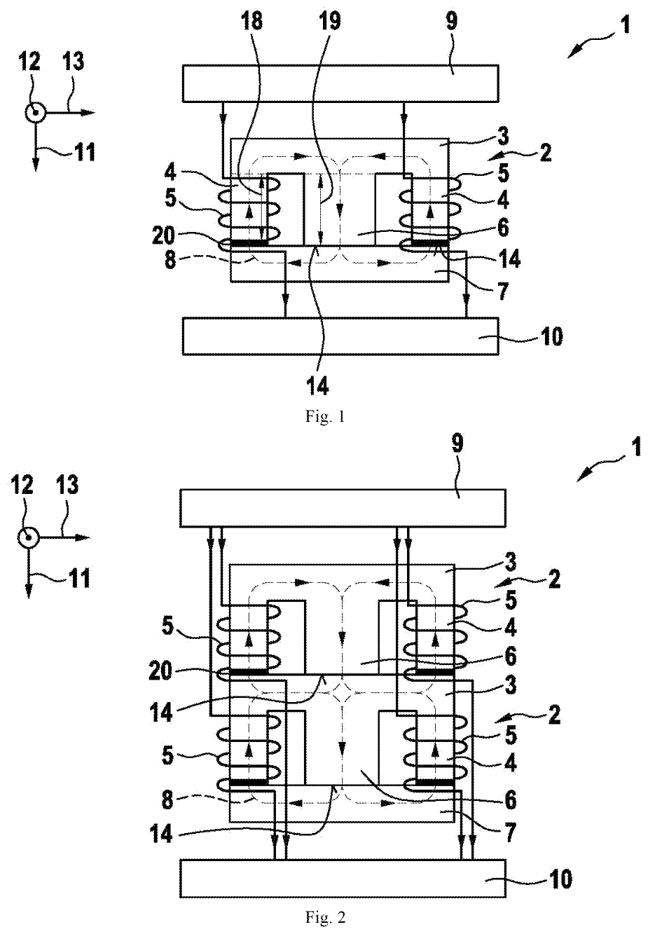

FIG. 1 shows a schematic side view of a choke assembly 1 according to a first embodiment of the present disclosure.

The choke assembly 1 of the first embodiment comprises one rake-shaped core 2 and one bar-shaped yoke core 7. Herein, “rake-shaped” means generally having the shape of a rake (garden tool). Alternatively, “comb-shaped” may also suitably describe the shape of the rake-shaped core 2.

The rake-shaped core 2 includes a body portion 3, two winding legs 4, and one return leg 6. Further, one electrical winding 5 is wound around each winding leg 4. No electrical winding is provided wound around the return leg 6. The two winding legs 4 and the return leg 6 extend from the body portion 3 in a first direction 11. The first direction 11 may also be referred to as a thickness direction of the choke assembly 1.

The winding legs 4 and the return leg 6 are alternately arranged in a third direction 13. The third direction 13 may also be referred to as a length direction 13 of the rake-shaped core 2. In other words, the return leg 6 and the winding legs 4 alternate in the length direction 13 of the rake-shaped core 2.

The electrical winding 5 of one winding leg 4 is preferably not directly electrically connected to the electrical winding 5 of the other winding leg 4. In other words, the choke assembly 1 preferably does not include any wires which are wound around one winding leg 4 and extend to another winding leg 4, so as to also be wound around the other winding leg 4. Therefore, the choke assembly 1 preferably comprises a plurality of chokes, which are each defined by an electrical winding 5 of one winding leg 4. In the example shown in FIG. 1, the choke assembly 1 thus comprises two chokes.

The choke assembly 1 comprises a choke assembly input circuit 9 and a choke assembly output circuit 10. The electrical winding 5 of each winding leg 4 is directly connected to the choke assembly input circuit 9 and the choke assembly output circuit 10, respectively. In other words, the electrical wire of the respective electrical winding 5 has one end connected to the choke assembly input circuit 9, has a portion wound around the respective winding leg 4, and has a further end, opposite to the end connected to the choke assembly input circuit 9, that is connected to the choke assembly output circuit 10.

When a current is input into the electrical winding 5, a magnetic field 8 (magnetic circuit 8) is generated in the respective winding leg 4. The yoke core 7 connected to the rake-shaped core 2 is configured to close the magnetic circuit 8 generated between the two winding legs 4 and the return leg 6.

In the present embodiment, end faces 14 of the winding legs 4 are not in contact with the yoke core 7. Instead, an air gap 20 is formed between the end faces 14 of the winding legs 4 and the yoke core 7. This air gap 20 may also be filled with a thermally or magnetically well-conducting material. Preferably, this material does not, or only poorly, electrically conduct. The air gap 20 suitably sets an inductance of the choke assembly 1. Further, an end face 14 of the return leg 6 is in contact with the yoke core 7. Alternatively, an air gap may also be formed between the end face 14 of the return leg 6 and the yoke core 7.

Herein, in order to achieve the air gap 20, a length 18 in the first direction 11 of the winding legs 4 is shorter than a length 19 in the first direction 11 of the return leg 6, so as to form the gap 20 at the end face 14 of the winding leg 4 opposite to the body portion 3.

Next, a stacking of the rake-shaped core 2 and the yoke core 7 in the first direction 11 will be described with reference to FIGS. 2-6.

FIG. 2 shows a schematic side view of a choke assembly 1 according to a second embodiment of the present disclosure.

In the present embodiment, the choke assembly 1 comprises two rake-shaped cores 2 and one yoke core 7. Herein, each rake-shaped core 2 comprises two winding legs 4 and one return leg 6. The yoke core 7 is bar-shaped. In the first direction 11, the first rake-shaped core 2 (top rake-shaped core 2) is stacked on top of the second rake-shaped core 2 (bottom rake-shaped core 2) and the second rake-shaped core 2 is stacked on top of the yoke core 7. Thus, the choke assembly 1 of the present embodiment preferably comprises four chokes.

The legs 4, 6 of the first rake-shaped core 2 face the body portion 3 of the second rake-shaped core 2. The legs of the second rake-shaped core 2 face the yoke core 7.

An air gap 20 is respectively formed between the winding legs 4 of the first rake-shaped core 2 and the body portion 3 of the second rake-shaped core 2. An air gap 20 is also respectively formed between the winding legs 4 of the second rake-shaped 2 and the yoke core 7.

Alternatively or in addition to the shown air gaps 20, an air gap (not shown) may also be formed between the end face 14 of the return leg 6 of the first rake-shaped core 2 and the body portion 3 of the second rake-shaped core 2 and/or be formed between the end face 14 of the return leg 6 of the second rake-shaped core 2 and the yoke core 7.

As shown in FIG. 2, in this example, the return leg 6 of the first rake-shaped core 2 is in contact with the body portion 3 of the second rake-shaped core 2. The return leg 6 of the second rake-shaped core 2 is in contact with the yoke core 7.

Further, as can be taken from FIG. 2, each electrical winding 5 is connected directly to the choke assembly input circuit 9 and the choke assembly output circuit 10, without any further elements, especially without other winding portions wound around a different winding leg 4, connected therebetween.

The body portion 3 of the second rake-shaped core 2 closes the magnetic circuit 8 of the first rake-shaped core 2. Further, the yoke core 7 closes the magnetic circuit 8 of the second rake-shaped core 2.

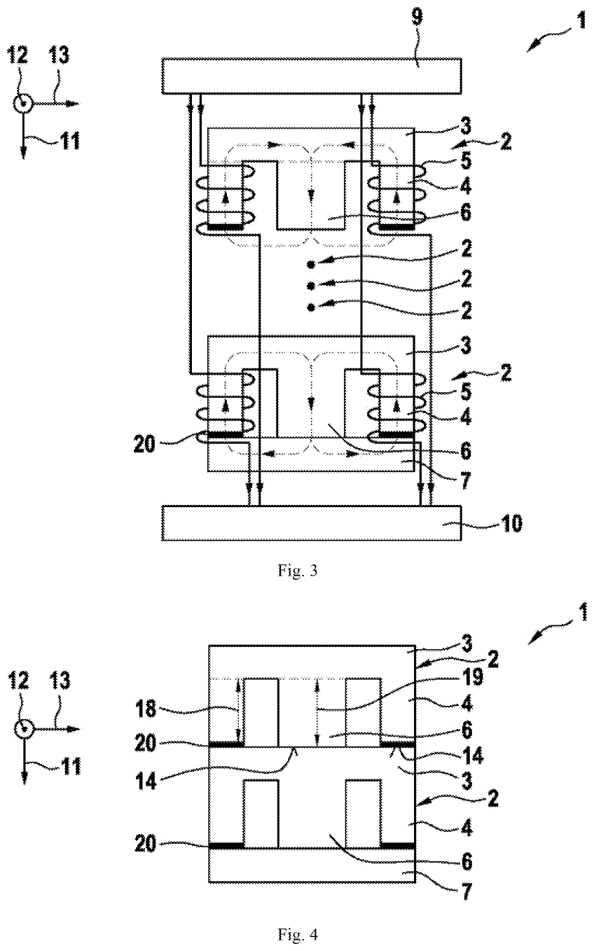

FIG. 3 shows a schematic side view of a choke assembly 1 according to a third embodiment of the present disclosure.

In particular, FIG. 3 shows a schematic extension of aforementioned stacking possibility along the first direction 11. Therein, any number of rake-shaped cores 2 may be stacked in the first direction 11 on top each other and on top of the yoke core 7.

In particular, as elucidated above with regard to FIG. 2, two rake-shaped cores 2 may be stacked in the first direction 11. However, the choke assembly 1 may also comprise three or four or five or more rake-shaped cores 2 stacked in the first direction 11.

Therein, the electrical windings 5 of each winding leg 4 of each rake-shaped core 2 is connected directly between the choke assembly input circuit 9 and the choke assembly output circuit 10, as mentioned above.

FIGS. 4-6 show schematic side views of a choke assembly 1, wherein the choke assembly input circuit 9, the choke assembly output circuit 10, the electrical windings 5, and the magnetic circuits 8 have been left out for higher simplicity and understanding of the drawings. Of course, these are to be understood as respectively included in the devices shown therein.

FIG. 4 shows a schematic side view of cores 2, 7 of the choke assembly 1 according to the second embodiment of the present disclosure. In other words, FIG. 4 is a simplified repetition of FIG. 2 for ease of understanding.

Therein, as explained above, in the first direction 11, a first rake-shaped core 2 is stacked on a second rake-shaped core 2 and the second rake-shaped core 2 is stacked on the yoke core 7. Further, legs 4, 6 of the first rake-shaped core 2 face the second rake-shaped core 2 and legs 4, 6 of the second rake-shaped core 2 face the yoke core 7.

This configuration may also be referred to as “EEI-configuration”, wherein “E” denotes the rake-shaped core 2 with three legs 4, 6 in total and “I” denotes the bar-shaped yoke core 7.

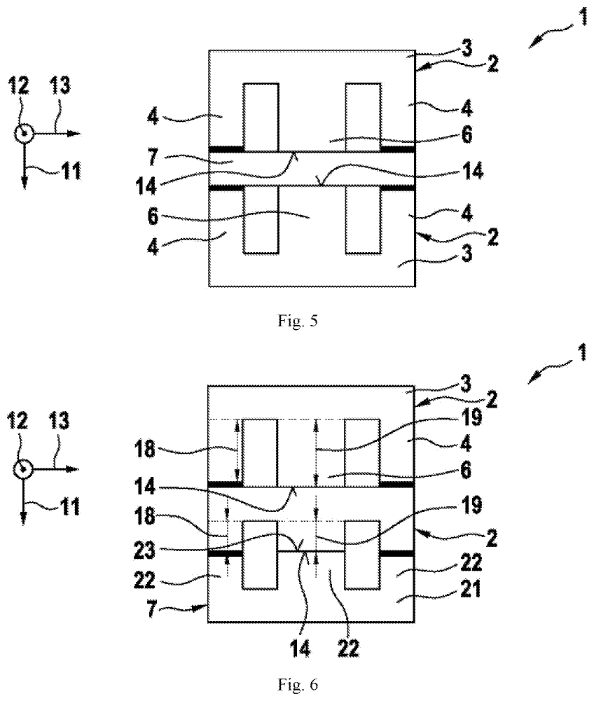

FIG. 5 shows a schematic side view of cores 2, 7 of a choke assembly 1 according to a fourth embodiment of the present disclosure.

In the present embodiment, in the first direction 11, a first rake-shaped core 2 is stacked on top of a yoke core 7 and the yoke core 7 is stacked on top of a second rake-shaped core 2.

Therein, both rake-shaped cores 2 face the yoke core 7. In other words, the legs 4, 6 of both rake-shaped cores 2 face the yoke core 7.

Further, air gaps 20 are provided between the winding legs 4 of both rake-shaped cores 2 and the yoke core 7. The return legs 6 of both rake-shaped cores 2 contact the yoke core 7. Thereby, the yoke core 7 closes the magnetic circuits of both rake-shaped cores 2. Alternatively, an air gap may also be formed between the end face 14 of the return leg 6 of each of the rake-shaped cores 2 and the yoke core 7.

This configuration may also be accordingly referred to as “EIE-configuration”.

FIG. 6 shows a schematic side view of cores 2, 7 of a choke assembly 1 according to a fifth embodiment of the present disclosure.

In the present embodiment, the choke assembly 1 comprises two rake-shaped cores 2 and one yoke core 7. Herein, each rake-shaped core 2 comprises two winding legs 4 and one return leg 6.

The yoke core 7 comprises three leg portions 22 and a body portion 21. In other words, the yoke core 7 may also be rake-shaped.

A first rake-shaped core 2 is stacked, in the first direction 11, on top of a second rake-shaped core 2 and the second rake-shaped core 2 is stacked on top of the yoke core 7.

The legs 22 of the yoke core 7, in particular the end faces 23 of the legs 22 of the yoke core 7, face the end faces 14 of the legs 4, 6 of the second rake-shaped core 2. A gap 20 is provided between the winding legs 4 of the second rake-shaped core 2 and the legs 22 of the yoke core 7 (outermost, i.e. left and right, legs 22) opposing the winding legs 4 of the rake-shaped core 2.

Preferably, no gap is provided between the (third, middle) leg 22 of the yoke core 7 and the return leg 6 of the second rake-shaped core 2 opposing said leg 22 of the yoke core 7. Alternatively or in addition to the shown air gaps 20, an air gap may be formed between the (third, middle) leg 22 of the yoke core 7 and the return leg 6 of the second rake-shaped core 2 opposing said leg 22 of the yoke core 7.

As a comparison between FIG. 6 and FIG. 4 or FIG. 5 shows, in the fifth embodiment (FIG. 6), a length 18 in the first direction 11 of the winding legs 4 of the second rake-shaped core 2, i.e. the rake-shaped core 2 neighboring the yoke core 7, is shorter than a length 18 in the first direction 11 of the winding legs 4 of the first rake-shaped core 2, i.e. the top rake-shaped core 2 not neighboring the yoke core 7. Further, a length 19 in the first direction 11 of the return leg 6 of the second rake-shaped core 2 is shorter than a length 19 in the first direction 11 of the return leg 6 of the first rake-shaped core 2. Thereby, a total length in the first direction 11 of the choke assembly 1 is the same as that of embodiments three and four (FIG. 4 and FIG. 5), even though the yoke core 7 comprises leg portions 22 with a non-zero length in the first direction 11.

This configuration may also be accordingly referred to as “EEE-configuration” or “EEI-configuration”.

The yoke core 7 closes the magnetic circuit of the second rake-shaped core 2 (bottom rake-shaped core 2). Further, the second rake-shaped core 2, the body portion 3 of which faces the legs 4, 6 of the first rake-shaped core 2 (top rake-shaped core 2), closes the magnetic circuit of the first rake-shaped core 2.

In the following, alternative embodiments employing different structures of rake-shaped cores 2 and yoke cores 7 will be described with reference to FIGS. 7 to 12. The foregoing explanations with reference to FIGS. 1 to 6 will not be repeated in their entirety, although these apply accordingly to the following embodiments.

FIG. 7 shows a schematic side view of a choke assembly 1 according to a sixth embodiment of the present disclosure.

Therein, most notably in comparison with the first embodiment of the present disclosure, the choke assembly 1 comprises one rake-shaped core 2 and one yoke core 7, wherein the rake-shaped core 2 comprises a total of five legs 4, 6.

In particular, the rake-shaped core 2 comprises three winding legs 4, each of which includes an electrical winding 5. As elucidated above, the electrical winding 5 of each winding leg 4 is directly connected between the choke assembly input circuit 9 and the choke assembly output circuit 10. Preferably, the choke assembly core 1 thus comprises three chokes.

Further, the rake-shaped core 2 comprises two return legs 6.

Preferably, in the second direction 13, the winding legs 4 and the return legs 6 are arranged in an alternating manner. In other words, starting from the left most side of the choke assembly 1, in the second direction 13, the rake-shaped core 2 comprises a first winding leg 4, a first return leg 6, a second winding leg 4, a second return leg 6, and a third winding leg 4. In other words, one return leg 6 is provided for each pair (between left and middle winding legs 4, and between middle and right winding legs 4) of neighboring winding legs 4.

The shown configuration may also be referred to as “WI-configuration”, wherein “W” corresponds to the rake-shaped core 2 including five legs 4, 6, and “I” corresponds to the bar-shaped yoke core 7.

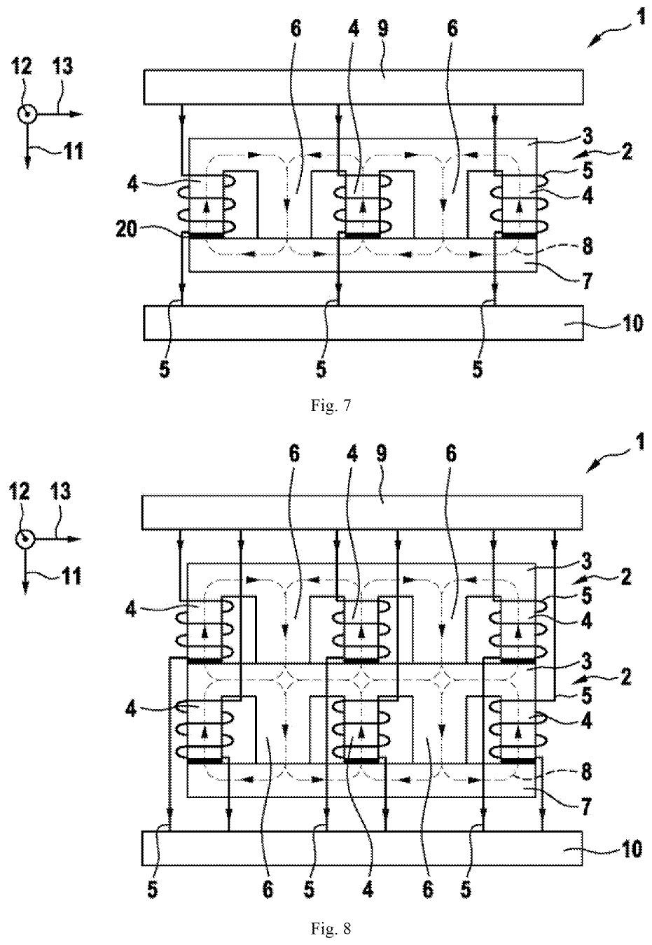

FIG. 8 shows a schematic side view of a choke assembly 1 according to a seventh embodiment of the present disclosure. FIG. 8 essentially shows a combination of embodiments six and two (FIG. 7 and FIG. 2).

In the present embodiment, the choke assembly 1 comprises two rake-shaped cores 2, each comprising three winding legs 4 and two return legs 6 between the pairs of winding legs 4. Therefore, the choke assembly 1 of the present embodiment preferably comprises six chokes.

As shown in FIG. 8, the two rake-shaped cores 2 are stacked on top of each other in the first direction 11. In other words, the choke assembly comprises a first rake-shaped core 2 stacked on top of a second rake-shaped core 2, wherein the second rake-shaped core 2 is stacked on top of a yoke core 7.

Further, the electrical windings 5 of each winding leg 4 of both rake-shaped cores 2 are directly connected to and between the choke assembly input circuit 9 and the choke assembly output circuit 10.

This configuration may also be referred to as “WWI-configuration”, accordingly.

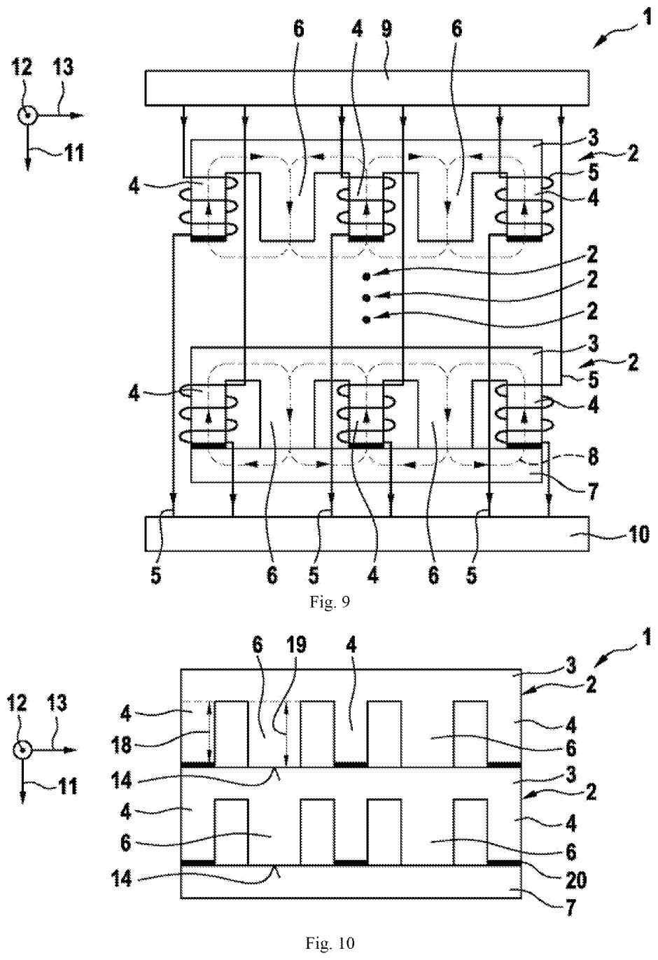

FIG. 9 shows a schematic side view of a choke assembly 1 according to an eighth embodiment of the present disclosure. FIG. 9 essentially shows a combination of embodiments six and three (FIG. 7 and FIG. 3).

In particular, FIG. 9 shows a schematic extension of aforementioned stacking possibility along the first direction 11. Therein, any number of rake-shaped cores 2 with five legs 4, 6 may be stacked in the first direction 11 on top each other and on top of the yoke core 7.

In particular, as elucidated above with regard to FIG. 8, two rake-shaped cores 2 may be stacked in the first direction 11. However, the choke assembly 1 may also comprise three or four or five or more rake-shaped cores 2 stacked in the first direction 11.

Therein, the electrical windings 5 of each winding leg 4 of each rake-shaped core 2 is connected directly between the choke assembly input circuit 9 and the choke assembly output circuit 10, as mentioned above.

FIGS. 10-12 show schematic side views of a choke assembly 1, wherein the choke assembly input circuit 9, the choke assembly output circuit 10, the electrical windings 5, and the magnetic circuits 8 have been left out for higher simplicity and understanding of the drawings. Of course, these are to be understood as respectively included in the devices shown therein.

Essentially, FIGS. 10 to 12 are an extension or combination of FIGS. 4 to 6 to rake-shaped cores 2 including five legs 4, 6.

FIG. 10 shows a schematic side view of cores 2, 7 of a choke assembly 1 according to the seventh (FIG. 8) embodiment of the present disclosure.

In the present embodiment, the choke assembly 1 comprises two rake-shaped cores 1 with five legs stacked in the first direction 11. In particular, the choke assembly 1 comprises a first rake-shaped core 2 stacked on top of a second rake-shaped core 2, wherein the second rake-shaped core 2 is stacked on a bar-shaped yoke core 7. Therein, the legs 4, 6 of the first rake-shaped core 2 face the body portion 3 of the second rake-shaped core 2. The legs 4, 6 of the second rake-shaped core 2 face the yoke core 7.

The configuration shown in FIG. 10 may also be referred to as “WWI-configuration”.

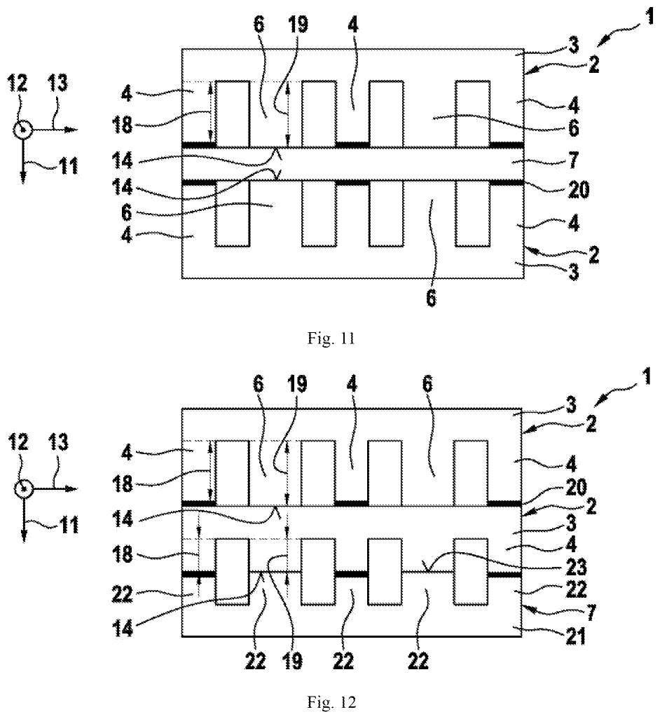

FIG. 11 shows a schematic side view of cores 2, 7 of a choke assembly 1 according to a ninth embodiment of the present disclosure.

Herein, the yoke core 7 is sandwiched between two rake-shaped cores 2. The legs 4, 6 of both rake-shaped cores 2 respectively face the yoke core 7.

Further, air gaps 20 are provided between the winding legs 4 of both rake-shaped cores 2 and the yoke core 7. The return legs 6 of both rake-shaped cores 2 contact the yoke core 7. Thereby, the yoke core 7 closes the magnetic circuits of both rake-shaped cores 2.

This configuration may also be accordingly referred to as “WIW-configuration”.

FIG. 12 shows a schematic side view of cores 2, 7 of a choke assembly 1 according to a tenth embodiment of the present disclosure.

In the present embodiment, the choke assembly 1 comprises two rake-shaped cores 2 and one yoke core 7. Herein, each rake-shaped core 2 comprises three winding legs 4 and two return legs 6.

The yoke core 7 comprises five leg portions 22 and a body portion 21.

A first rake-shaped core 2 is stacked, in the first direction 11, on top of a second rake-shaped core 2 and the second rake-shaped core 2 is stacked on top of the yoke core 7.

The legs 22 of the yoke core 7, in particular the end faces 23 of the legs 22 of the yoke core 7, face the end faces 14 of the legs 4, 6 of the second rake-shaped core 2. A gap 20 is provided between the winding legs 4 of the second rake-shaped core 2 and the legs 22 of the yoke core 7 (outermost, i.e. left and right, and middle legs 22) opposing the winding legs 4 of the rake-shaped core 2.

Preferably, no gap is provided between the (from the left, second and fourth) leg 22 of the yoke core 7 and the opposing return leg 6 of the second rake-shaped core 2 opposing said leg 22 of the yoke core 7.

As a comparison between FIG. 12 and FIG. 10 or FIG. 11 shows, in the tenth embodiment (FIG. 12), a length 18 in the first direction 11 of the winding legs 4 of the second rake-shaped core 2, i.e. the rake-shaped core 2 neighboring the yoke core 7, is shorter than a length 18 in the first direction 11 of the winding legs 4 of the first rake-shaped core 2, i.e. the top rake-shaped core 2 not neighboring the yoke core 7. Further, a length 19 in the first direction 11 of the return legs 6 of the second rake-shaped core 2 is shorter than a length 19 in the first direction 11 of the return legs 6 of the first rake-shaped core 2. Thereby, a total length in the first direction 11 of the choke assembly 1 is the same as that of embodiments seven and nine (FIG. 10 and FIG. 11), even though the yoke core 7 comprises leg portions 22 with a non-zero length in the first direction 11.

The yoke core 7 closes the magnetic circuit of the second rake-shaped core 2 (bottom rake-shaped core 2). Further, the second rake-shaped core 2, the body portion 3 of which faces the legs 4, 6 of the first rake-shaped core 2 (top rake-shaped core 2), closes the magnetic circuit of the first rake-shaped core 2.

This configuration may also be accordingly referred to as “WWW-configuration”.

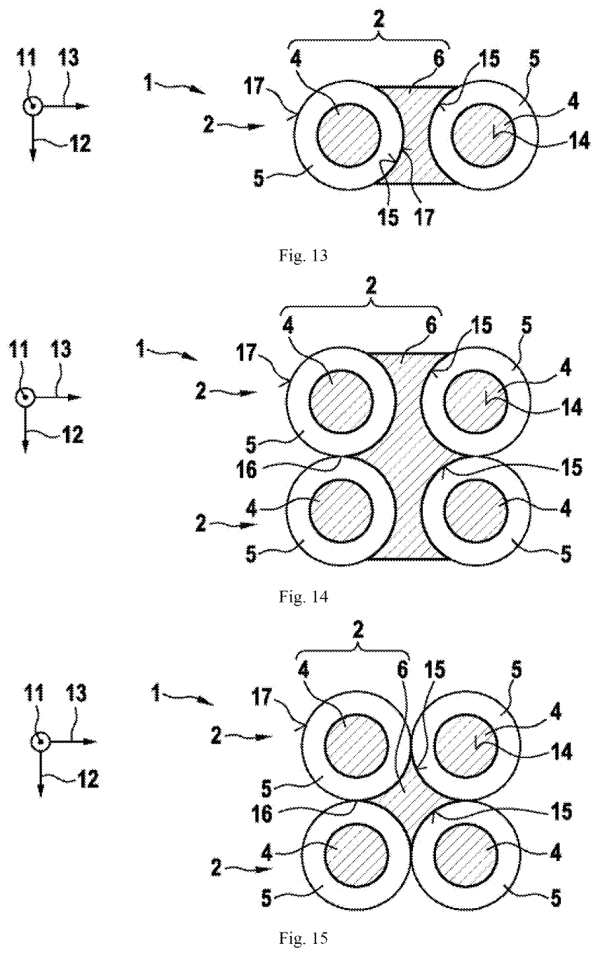

Now, with reference to FIGS. 13 to 18, plan-view (cross-sectional) configurations of different embodiments of the present disclosure will be described. In particular, the following configurations are to be understood as in addition or alternatively to the foregoing described embodiments.

FIG. 13 shows a schematic plan view of a choke assembly 1 according to an eleventh embodiment of the present disclosure. In particular, FIG. 13 shows a three-legged rake-shaped core 2. Since the yoke core 7 is not shown therein, FIG. 13 may also be understood as a cross-sectional view of the choke assembly 1.

As can be taken from FIG. 13, the rake-shaped core 2 comprises two winding legs 4 and one return leg 6. In particular, end faces 14 of the respective legs 4, 6 are shown. In other words, FIG. 13 shows a “E-configuration” of the rake-shaped core 2.

As shown, the end faces 14, and with them the cross-sections, of the winding legs 4 are round, especially circular. On the other hand, the cross-sections of the winding legs 4 can be rectangular, especially square. In such a case, when winding electrical windings 5 around such rectangular or square winding legs 4, an outer surface 17 of the electrical windings 5 may, as a result, be oval or elliptical.

Further, electrical windings 5 are shown wound around each winding leg 4, wherein the outer surface 17 of the electrical windings 5 is circular. However, the outer surface 17 (i.e. the cross-section of the electrical windings 5) may be rectangular or oval/elliptical.

The return leg 6 comprises two concave outer surfaces 15, the shape of each of which corresponding to the shape (circular) of the outer surface 17 of the electrical winding 5 of the adjacent winding leg 4. In other words, the left concave outer surface 15 corresponds to the shape of the left electrical winding 5 and the shape of the right concave outer surface 15 of the return leg 6 corresponds to the shape of the right electrical winding 5. In the case that the electrical windings 5 are rectangular, the portions of the return leg 6 corresponding here to the concave surfaces 15 are also rectangular, i.e. corresponding to the shape of the outer surface 17 of the respective electrical winding 5. Of course, some electrical windings 5 may be circular, while others are rectangular.

In this embodiment, the electrical windings 5 are in contact with the concave outer surfaces 15 of the return leg 6.

Further, the core 1 shown in FIG. 13 may comprise additional of these rake-shaped cores 2 stacked in the first direction 11 (depth direction of FIG. 13), as elucidated with regard to FIGS. 4 to 6, for example.

FIG. 14 shows a schematic plan view of a choke assembly 1 according to a twelfth embodiment of the present disclosure.

In particular, FIG. 14 shows the configuration in which two rake-shaped cores 2 (“E-configuration”) are stacked in the second direction 12, which is perpendicular to the first direction 11. In other words, in the second direction 12, the choke assembly 1 of this embodiment comprises a first rake-shaped core 2 stacked on top of a second rake-shaped core 2. Additional rake-shaped cores 2 may also be stacked in the first direction 11. In particular, the configuration shown in FIG. 14 may also be repetitively stacked in the first direction 11.

Essentially, FIG. 14 shows two rake-shaped cores 2 of FIG. 13 stacked in the second direction 12. Although not visible in FIG. 14 due to the cross-sectional view thereof, the body portions 3 (see: FIGS. 1 through 12) of the rake-shaped cores 2 are formed integrally with one another. In other words, the body portions 3 of two rake shaped cores 2 of FIG. 13 “morph” into one rake shaped core in FIG. 14.

Therein, the return legs 6 of multiple rake-shaped cores 2, which are stacked in the second direction 12, are formed integrally with one another, as shown in FIG. 14. In other words, one return leg 6 is formed for two rake-shaped cores 2 stacked in the second direction 12.

Further, in the second direction 12, the electrical windings 5 of the first rake-shaped core 2 are in contact with the respectively adjacent electrical windings 5 of the second rake-shaped core 2.

The concave outer surfaces 15 extend in the second direction 12 and the third direction 13 to between portions of neighboring electrical windings 5 not in contact with one another, wherein preferably other portions (contacting portions 16) between the neighboring electrical windings 5 are in contact with one another or are disposed with a preferably small gap between one another. In other words, the concave outer surfaces 15 extend to, but not including the contacting portions 16 or closest portions 16 of neighboring electrical windings 5.

Although the electrical windings 5 as shown are preferably mechanically or physically in contact with one another, these are not electrically connected to one another. In particular, the electrical windings 5 are electrically insulated from one another.

FIG. 15 shows a schematic plan view of a choke assembly 1 according to a thirteenth embodiment of the present disclosure.

In the present embodiment, as also in the twelfth embodiment, the choke assembly 1 comprises two rake-shaped cores 2 (“E-configuration”) stacked in the second direction 12. Herein, however, the electrical windings 5 adjacent to one another in the second direction 12 and the third direction 13 are in contact with one another. In other words, each electrical winding 5 contacts the neighboring or adjacent electrical winding 5, of the same or of the other rake-shaped core 2.

In this case, the return leg 6 includes only concave outer surfaces 15, corresponding to the shape of the outer surfaces 17 of all electrical windings 5. The concave outer surfaces 15 of the return leg 6 extend in the second direction 12 and the third direction 13 up to but not including contact portions 16 between the electrical windings 5.

The configuration shown in FIG. 15 may also be repetitively stacked in the first direction 11 and/or stacked with the configuration shown in FIG. 14 in the first direction 11.

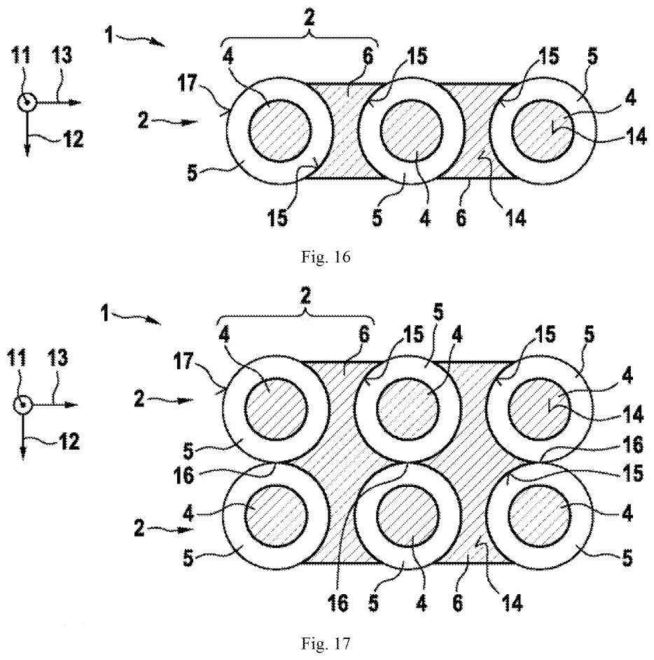

FIG. 16 shows a schematic plan view of a choke assembly 1 according to a fourteenth embodiment of the present disclosure. Essentially, FIG. 16 shows a combination or extension of the configuration shown in FIG. 13 to a five-legged rake-shaped core 2 (see for example FIG. 7).

Therein, the rake-shaped core 2 includes three winding legs 4 and two return legs 6. Each return leg 6 includes two concave outer surfaces 15 each facing one electrical winding 5 and having a shape corresponding to the adjacent electrical winding 5.

The configuration shown in FIG. 16 may also be repetitively stacked in the first direction 11.

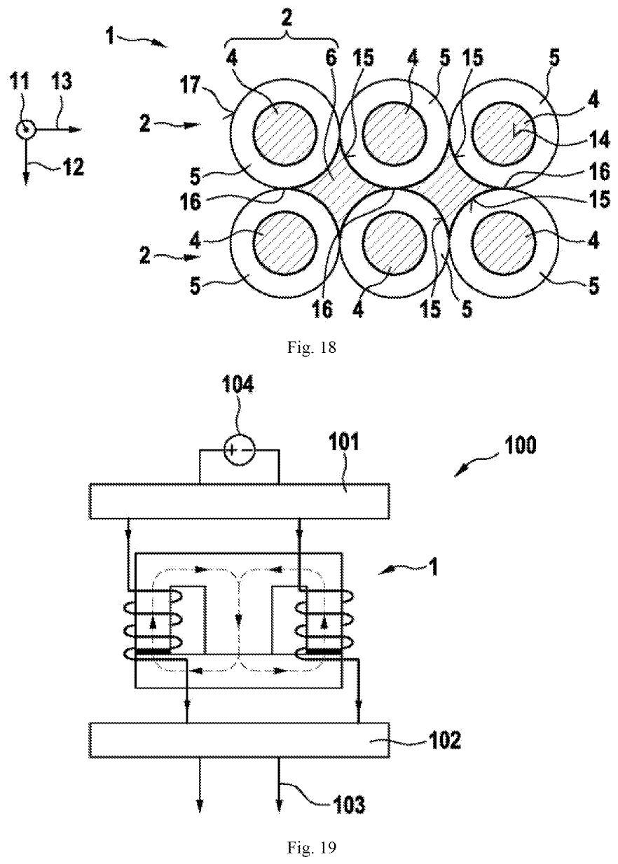

FIG. 17 shows a schematic plan view of a choke assembly 1 according to a fifteenth embodiment of the present disclosure. FIG. 17 essentially shows a combination of configurations shown in FIG. 14 and FIG. 16.

Therein, the configuration of the fourteenth embodiment is stacked in the second direction 12.

The return legs 6 of the two stacked rake-shaped cores 2 are formed integrally with one another. Therefore, the choke assembly 1 of the present embodiment comprises two return legs 6, each interposed between pairs of winding legs 4.

The concave outer surfaces 15 of the return legs 6 extend to but not including the contact portions 16 of adjacent (in the second direction 12) electrical windings 5. The electrical windings 5 adjacent to one another in the third direction 13 (with a return leg 6 interposed therebetween) do not contact one another.

The configuration shown in FIG. 17 may also be repetitively stacked in the first direction 11.

FIG. 18 shows a schematic plan view of a choke assembly 1 according to a sixteenth embodiment of the present disclosure. Essentially, FIG. 18 shows a combination of configurations shown in FIG. 17 and FIG. 15.

Therein, the two rake-shaped cores 2, each comprising five legs 4, 6, are stacked in the second direction 12, wherein each electrical winding 5 contacts every directly adjacent electrical winding 5, either of the same rake-shaped core 2 or of the stacked other rake-shaped core 2.

The return legs 6 of the two stacked rake-shaped cores 2 are formed integrally with one another. Therefore, the stacked rake-shaped cores 2 together form and include two return legs 6, interposed between pairs of winding legs 4 (in the third direction). In other words, the return legs 6 are interposed between pairs of two winding legs 4 in the second direction 12.

The concave outer surfaces 15 of the return legs 6 extend to but not including the contact portions 16 of all electrical windings 5.

The return legs 6 of this embodiment include only concave outer surfaces 15.

The configuration shown in FIG. 18 may also be repetitively stacked in the first direction 11, especially with the configuration shown in FIG. 17.

The foregoing described embodiments show rake-shaped cores 2 comprising three or five legs 4, 6. It is to be understood that the rake-shaped cores 2 may also comprise four or more than five legs 4, 6. Preferably, the rake-shaped cores 2 comprise an uneven amount of legs 4, 6, so as to have return legs 6 interposing the winding legs 4. For example, the rake-shaped cores 2 may comprise seven or nine or more legs 4, 6. In the case of seven legs 4, 6, the rake-shaped core 2 preferably comprises three return legs 6 and four winding legs 4. In the case of nine legs 4, 6, the rake shaped core 2 preferably comprises four return legs 6 and five winding legs 4.

Further, any number of the foregoing described rake-shaped cores 2 may be stacked in the first direction 11, the second direction 12 and/or the third direction 13. A stacking in the third direction 13 preferably corresponds to adding more legs 4, 6 to the rake-shaped core(s) 2.

FIG. 19 shows a schematic diagram of an electric conversion device 100 according to the present disclosure.

The electric conversion device 100 comprises a choke assembly 1 according to any one of the foregoing embodiments. In particular, the electric conversion device 100 comprises the choke assembly 1 according to the first embodiment.

Therein, a power source 104 inputs voltage and current into a converter input 101 of the electric conversion device 100. The converter input 101 may be a transformer or a connection terminal for inputting the signal into the choke assembly 1.

The choke assembly 1 is connected to a choke assembly output 102, which in this case may be an input for a transformer or a connection terminal for outputting the signal from the choke assembly 1.

The choke assembly output 102 is connected to an electric conversion device output 103, which outputs the signal from the entire electric conversion device 100.

In addition to the foregoing written explanation of the disclosure, it is explicitly referred to FIGS. 1 to 19, which in detail show features of the disclosure.

What is claimed is:

1. A choke assembly for an electric conversion device, comprising:
at least one rake-shaped core respectively including a body portion, at least two winding legs, around each of which at least one electrical winding is wound, and at least one return leg, the at least two winding legs and the at least one return leg extending from the body portion in a first direction; and
at least one yoke core connected to at least one rake-shaped core and configured to close a magnetic circuit between the at least two winding legs and the at least one return leg of the at least one rake-shaped core.

2. The choke assembly according to claim 1, wherein the electrical winding of one winding leg is not directly electrically connected to the electrical winding of any further winding leg.

3. The choke assembly according to claim 1, further comprising a choke assembly input circuit and a choke assembly output circuit, wherein the electrical winding of each winding leg is directly connected to the choke assembly input circuit and the choke assembly output circuit.

4. The choke assembly according to claim 1, wherein each rake-shaped core includes one return leg for each pair of directly neighboring winding legs.

5. The choke assembly according to claim 1, wherein at least two rake-shaped cores are stacked in the first direction such that end faces of the at least two winding legs and of the at least one return leg of one rake-shaped core face the body portion of a further rake-shaped core.

6. The choke assembly according to claim 1, wherein at least two rake-shaped cores are stacked in the first direction such that the end faces of the at least two winding legs and of the at least one return leg of one rake-shaped core face opposite end faces of respective legs of a further rake-shaped core.

7. The choke assembly according to claim 1, wherein at least two rake-shaped cores are stacked in the first direction such that the end faces of the at least two winding legs and of the at least one return leg of at least one rake-shaped core face the at least one yoke core.

8. The choke assembly according to claim 1, wherein at least two rake-shaped cores are stacked in a second direction perpendicular to the first direction, wherein the return legs of the at least two rake-shaped cores stacked in the second direction are formed integrally with one another.

9. The choke assembly according to claim 8, wherein at least two electrical windings, respectively wound around different winding legs, are in physical contact with one another.

10. The choke assembly according to claim 1, wherein the at least one return leg comprises a plurality of concave outer surfaces, the shape of each of which corresponds to a shape of an outer surface of an electrical winding of the adjacent winding leg.

11. The choke assembly according to claim 1, wherein a length in the first direction of the winding leg(s) is shorter than a length in the first direction of the return leg(s), so as to form at least one gap at an end of the winding leg(s) opposite to the body portion.

12. The choke assembly according to claim 1, wherein at least the outermost legs out of all winding legs and the return leg(s) are winding legs.

13. The choke assembly according to claim 1, wherein the choke assembly is a surface mounted device mounted on a circuit board.

14. An electric conversion device, comprising at least one choke assembly, at least one transformer and at least one converter;
wherein the choke assembly comprises:
at least one rake-shaped core respectively including a body portion, at least two winding legs, around each of which at least one electrical winding is wound, and at least one return leg, the at least two winding legs and the at least one return leg extending from the body portion in a first direction; and
at least one yoke core connected to at least one rake-shaped core and configured to close a magnetic circuit between the at least two winding legs and the at least one return leg of the at least one rake-shaped core.

15. The electric conversion device according to claim 14, wherein the electrical winding of one winding leg is not directly electrically connected to the electrical winding of any further winding leg.

16. The electric conversion device according to claim 14, wherein the choke assembly further comprises a choke assembly input circuit and a choke assembly output circuit, wherein the electrical winding of each winding leg is directly connected to the choke assembly input circuit and the choke assembly output circuit.

17. The electric conversion device according to claim 14, wherein each rake-shaped core includes one return leg for each pair of directly neighboring winding legs.

18. The electric conversion device according to claim 14, wherein at least two rake-shaped cores are stacked in the first direction such that end faces of the at least two winding legs and of the at least one return leg of one rake-shaped core face the body portion of a further rake-shaped core.

19. The electric conversion device according to claim 14, wherein at least two rake-shaped cores are stacked in the first direction such that the end faces of the at least two winding legs and of the at least one return leg of one rake-shaped core face opposite end faces of respective legs of a further rake-shaped core.

20. The electric conversion device according to claim 14, wherein at least two rake-shaped cores are stacked in the first direction such that the end faces of the at least two winding legs and of the at least one return leg of at least one rake-shaped core face the at least one yoke core.
